(19) United States
(12) Patent Application Publication
(10) Pub. No.: US 2010/0141696 A1
(43) Pub. Date: Jun. 10, 2010

(54) EJECTING METHOD AND EJECTING APPARATUS

(75) Inventor: Kazutoshi FUJISAWA, Okaya-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/631,575

(22) Filed: Dec. 4, 2009

(30) Foreign Application Priority Data
Dec. 5, 2008 (JP) 2008-311327

(51) Int. Cl. B41J 29/38

(52) U.S. Cl. 347/9; 347/16

(57) ABSTRACT

Provided is a method of ejecting a coating agent cured by irradiation of an electromagnetic wave, the method including: a first operation which ejects the coating agent onto a medium; a second operation which is performed after the first operation so as to irradiate an electromagnetic wave to the coating agent ejected onto the medium in the first operation; a third operation which is performed after the second operation so as to eject the coating agent onto the medium; and a fourth operation which is performed after the third operation so as to irradiate the electromagnetic wave to the coating agent ejected onto the medium in the third operation.

This application claims the benefit of Japanese Patent Application No. 2008-311327, filed Dec. 5, 2008, which is expressly incorporated herein by reference in its entirety.

### BACKGROUND

1. Technical Field

The present invention relates to an ejecting method and an ejecting apparatus.

2. Related Art

As an ejecting apparatus for performing an ejecting method, there is known an ink jet printer which prints an image by ejecting a fluid (for example, ink) onto various media such as a paper sheet, a cloth, and a film.

Among printers, there is a printer which ejects ink (UV curing ink) cured by irradiation of UV light. In addition, in order to obtain a glossy image, JP-A-2006-159684 proposes a printing method of forming an image by ejecting colored ink onto a medium and ejecting transparent ink (hereinafter, referred to as a coating agent) onto the image.

However, the transparent UV curing ink is easily bounced on the image printed by the colored UV curing ink. For this reason, when the coating agent is ejected once onto the image, the coating agent is formed in a large round particle shape on the image. When the coating agent is cured in the round particle shape, the image surface has an uneven shape. As a result, it is not possible to obtain a glossy image.

### SUMMARY

An advantage of some aspects of the invention is that it provides an ejecting method and an ejecting apparatus capable of obtaining a glossy image by using a coating agent.

In order to achieve the above-described object, according to an aspect of the invention, there is provided a method of ejecting a coating agent cured by irradiation of an electromagnetic wave, the method including: a first operation which ejects the coating agent onto a medium; a second operation which is performed after the first operation so as to irradiate an electromagnetic wave to the coating agent ejected onto the medium in the first operation; a third operation which is performed after the second operation so as to eject the coating agent onto the medium; and a fourth operation which is performed after the third operation so as to irradiate the electromagnetic wave to the coating agent ejected onto the medium in the third operation.

The other characteristics of the invention will be apparent from the description of the specification and the accompanying drawings.

### BRIEF DESCRIPTION OF THE DRAWINGS

The invention will be described with reference to the accompanying drawings, wherein like numbers reference like elements.

FIG. 1 is a block diagram illustrating an entire configuration of a printer according to an embodiment.

FIG. 2A is a sectional view illustrating the printer, and

FIG. 2B is a plan view illustrating a head unit and a UV light irradiating unit.

FIG. 3 is a diagram illustrating a printing method according to a comparative example.

FIG. 4 is a flowchart illustrating a printing method according to the embodiment.

FIG. 5 is a diagram illustrating the printing method according to the embodiment.

FIG. 6 is a diagram illustrating a pixel to which a coating agent is ejected.

FIG. 7 is a diagram illustrating a coating agent ejecting method according to a modified example.

FIGS. 8A, 8B, and 8C are a diagram illustrating the coating agent ejecting method according to the modified example.

### DESCRIPTION OF EXEMPLARY EMBODIMENTS

At least the following points will be apparent by the description of the specification and the accompanying drawings.

That is, there is provided a method of ejecting a coating agent cured by irradiation of an electromagnetic wave, the method including: a first operation which ejects the coating agent onto a medium; a second operation which is performed after the first operation so as to irradiate an electromagnetic wave to the coating agent ejected onto the medium in the first operation; a third operation which is performed after the second operation so as to eject the coating agent onto the medium; and a fourth operation which is performed after the third operation so as to irradiate the electromagnetic wave to the coating agent ejected onto the medium in the third operation.

According to the ejecting method, since it is possible to cure the coating agent so as to be comparatively flat, it is possible to obtain a glossy image on the medium.

In the ejecting method, an amount of the coating agent ejected from one nozzle in the first operation is smaller than an amount of the coating agent ejected from one nozzle in the third operation.

According to the ejecting method, since the coating agent ejected in the first operation is cured in the form of small particles, it is possible to fill a gap between the particles with the coating agent ejected in the third operation. As a result, it is possible to cure the coating agent so as to be comparatively flat.

In the ejecting method, energy of the electromagnetic wave irradiated to the coating agent in the second operation is weaker than energy of the electromagnetic wave irradiated to the coating agent in the fourth operation.

According to the ejecting method, it is possible to eject the coating agent in the third operation in the state where the coating agent ejected in the first operation is not perfectly cured. As a result, it is possible to easily merge the coating agents ejected two times (plural times), and to cure the coating agent to be flatter.

In the ejecting method, before the first operation, a colored fluid cured by the irradiation of the electromagnetic wave is ejected onto the medium, and then the electromagnetic wave is irradiated to the colored fluid ejected onto the medium so as to form an image on the medium. In the first operation, the coating agent is ejected onto the image.

According to the ejecting method, although the coating agent ejected onto the image formed by curing a colored fluid is easily bounced thereon and is formed in a particle state, it is possible to cure the coating agent to be comparatively flat. As a result, it is possible to obtain a glossy image.

In the ejecting method, a landing position of the coating agent ejected from nozzles onto the medium in the first operation is deviated from a landing position of the coating agent ejected from the nozzles onto the medium in the third operation.

According to the ejecting method, it is possible to easily fill a gap between the particles of the coating agents ejected in the first operation with the coating agents ejected in the third operation.

In the ejecting method, a dot gap when the coating agent ejected from the nozzles is landed on the medium in the first operation is equal to or less than a dot diameter when the coating agent ejected from one nozzle is landed on the medium in the third operation.

According to the ejecting method, it is possible to easily fill a gap between the particles of the coating agents ejected in the first operation with the coating agents ejected in the third operation.

In the ejecting method, a dot diameter when the coating agent ejected from one nozzle is landed on the medium in the first operation is smaller than a dot gap when the coating agent ejected from the nozzles is landed on the medium in the first operation.

According to the ejecting method, since it is possible to prevent a problem that the coating agents ejected from the nozzles in the first operation are connected to each other in disorder, it is possible to cure the coating agent in a comparatively small particle state.

There is provided an apparatus for ejecting a coating agent cured by irradiation of an electromagnetic wave, the apparatus including: a nozzle which ejects the coating agent; an irradiation unit which irradiates the electromagnetic wave for curing the coating agent; and a control unit which causes the apparatus to perform: a first operation which ejects the coating agent onto a medium; a second operation which is performed after the first operation so as to irradiate an electromagnetic wave to the coating agent ejected onto the medium in the first operation; a third operation which is performed after the second operation so as to eject the coating agent onto the medium; and a fourth operation which is performed after the third operation so as to irradiate the electromagnetic wave to the coating agent ejected onto the medium in the third operation.

According to the ejecting apparatus, since it is possible to cure the coating agent so as to be comparatively flat, it is possible to obtain a glossy image on the medium.

### Outline of Ink Jet Printer

An ink jet printer (hereinafter, referred to as a printer 1) will be exemplified as an example of the ejecting apparatus.

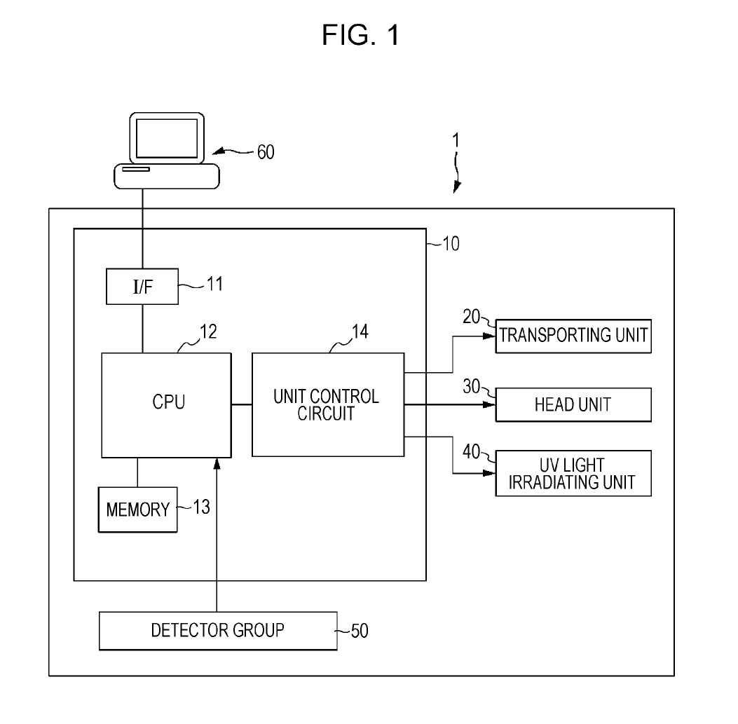

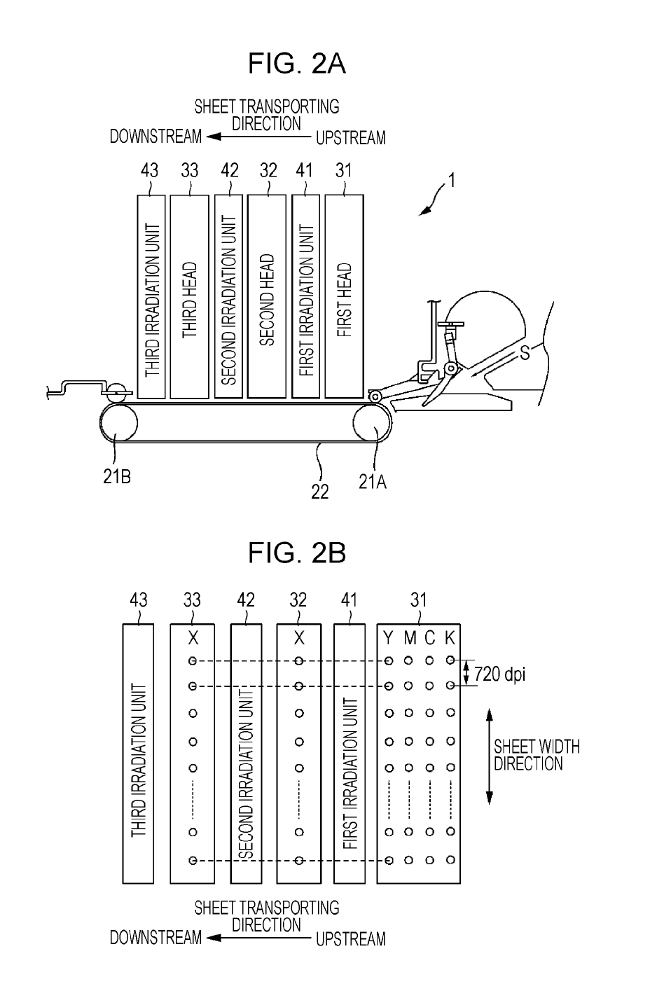

FIG. 1 is a block diagram showing an entire configuration of the printer 1 according to the embodiment. FIG. 2A is a sectional view illustrating the printer 1, and FIG. 2B is a plan view illustrating a head unit 30 and a UV light irradiating unit 40. The printer 1 that receives printing data from a computer 50 as an external device forms an image on a sheet S by controlling the respective units (a transporting unit 20, the head unit 30, and the UV light irradiating unit 40) through a controller 60. In addition, a detector group 50 monitors an internal status of the printer 1, and a controller 10 controls the respective units on the basis of the detection result.

The controller 10 is a control unit which performs a control of the printer 1. An interface unit 11 is used to send or receive data between the printer 1 and the computer 50 as the external device. A CPU 12 is a calculation processor which performs the entire control of the printer 1. A memory 13 is used to ensure an operation area or a storage area for storing a program of the CPU 12. The CPU 12 controls the respective units on the basis of the program stored in the memory 13 through a unit control circuit 14.

The transporting unit 20 includes transporting rollers 21A and 21B and a transporting belt 22, and sends the sheet S to a printing position and transports the sheet S in a sheet transporting direction at a predetermined transporting speed during the printing operation. When the loop-shaped transporting belt 22 is rotated by the transporting rollers 21A and 21B, the sheet S on the transporting belt 22 is transported. In addition, the positional deviation of the sheet is prevented in such a manner that the sheet is adsorbed onto the transporting belt 22 in a vacuum state.

The head unit 30 is used to eject ink onto the sheet S, and includes three heads (a first head 31, a second head 32, and a third head 33). The lower surface of each of the heads is provided with plural nozzles as ink ejecting portions. In addition, each of the nozzles is provided with a pressure chamber (not shown) into which ink enters and a driving element (for example, a piezoelectric element) which ejects ink by changing the volume of the pressure chamber. When a driving signal is applied to the driving element, the driving element is deformed, and the pressure chamber is expanded or contracted in accordance with the deformation, thereby ejecting the ink.

In this embodiment, “UV curing ink” which is cured by the irradiation of UV light (electromagnetic wave) is used as ink. Here, the UV curing ink is formed by adding a supplement such as defoamer or polymerization-inhibitor to a mixture of a vehicle, photopolymerization initiator, and pigment. In addition, the vehicle is formed by adjusting a viscosity of oligomer or monomer using reactive diluents having a photopolymerization curing property. In addition, the ink includes both water-based ink and oil-based ink.

Colored UV curing ink (hereinafter, referred to as color ink) is ejected from the first head 31. As shown in FIG. 2B, the lower surface of the first head 31 is provided with a yellow nozzle row Y for ejecting yellow ink, a magenta nozzle row M for ejecting magenta ink, a cyan nozzle row C for ejecting cyan ink, and a black nozzle row K for ejecting black ink. In each of the nozzle rows, plural nozzles are arranged at a predetermined gap (for example, 720 dpi) in a width direction as a direction intersecting the sheet transporting direction. Meanwhile, the same ink is ejected from the second head 32 and the third head 33, and colorless transparent UV curing ink (hereinafter, referred to as a coating agent) is ejected therefrom. Each of the lower surfaces of the second head 32 and the third head 33 is provided with one nozzle row X for ejecting the coating agent. In addition, as shown in the drawing, the nozzle rows YMCK for ejecting the color ink and the nozzle row X for ejecting the coating agent have the same nozzle positions in the sheet width direction.

The UV light irradiating unit 40 includes three irradiation units (a first irradiation unit 41, a second irradiation unit 42, and a third irradiation unit 43). Each of the irradiation units includes a lamp (for example, a metal halide lamp or an LED) which cures the color ink or the coating agent ejected onto the sheet S by irradiating UV light thereto. The first irradiation unit 41 is provided on the downstream side of the first head 31 in the sheet transporting direction, and cures the color ink ejected from the first head 31 onto the sheet S. In the same manner, the second irradiation unit 42 is provided on the downstream side of the second head 32 in the sheet transporting direction, and cures the coating agent ejected from the second head 32. The third irradiation unit 43 is provided on the downstream side of the third head 33 in the sheet transporting direction, and cures the coating agent ejected from the third head 33. In addition, when the energy or time of the UV light irradiated to the ink is adjusted, it is possible to almost perfectly cure the ink or to half cure the ink.

In the printer 1 having the above-described configuration, when the controller 10 receives the printing data, the controller 10 first sends the sheet S to be printed onto the transporting belt 22. The sheet S is transported on the transporting belt 22 at a constant speed without stopping. During a time when the sheet S passes through a position below the head and the irradiation unit, the ink is ejected from each of the heads onto the sheet S, and the ink on the sheet S is cured by each of the irradiation units. As a result, an image is printed on the sheet S.

### Printing Method (Coating Agent Ejecting Method)

Hereinafter, a printing method according to a comparative example different from this embodiment will be described first, and then a printing method (a coating agent ejecting method) according to this embodiment will be described in detail.

### Printing Method According to Comparative Example

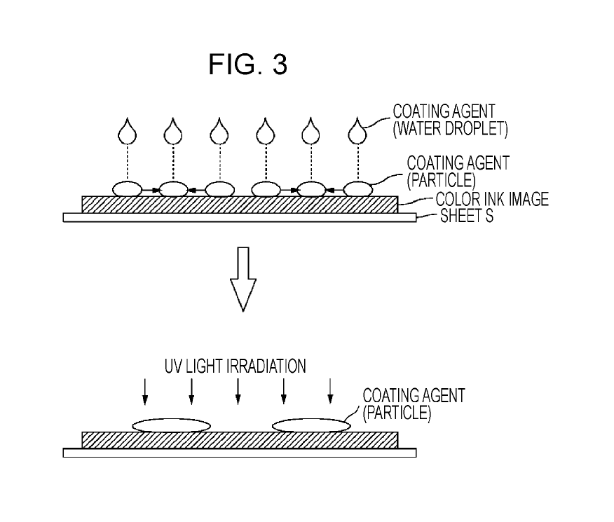

FIG. 3 is a diagram illustrating the printing method according to the comparative example. In the printing method according to the comparative example, first, an image is formed on the sheet S by using UV curing color ink. Here, the surface of the color ink image is formed in an uneven shape in accordance with a different ink overlapping state, and it is difficult to obtain a glossy image since light is diffused and reflected on the surface thereof (here, for convenience of description, it is assumed that the image surface is flat). Therefore, for the purpose of obtaining a glossy image by smoothening the image surface, colorless transparent coating agents are ejected onto the color ink image. In the comparative example, the coating agents are ejected once onto the entire surface of the color ink image. In addition, finally, the coating agents on the color ink image are cured by irradiating UV light thereto.

The image formed by UV curing color ink easily bounces water droplets of the coating agents landed on the image surface. As a result, each of the water droplets of the coating agents landed on the color ink image is maintained in the form of round particles as shown in FIG. 3 without spreading on the image surface. In addition, the particles of the coating agents ejected from each of the nozzles and landed on the image are connected to each other to thereby form a large particle which can be recognized by a person. Likewise, when the UV light is irradiated to the coating agents so as to cure the round large particle, the uneven state of the image surface deteriorates due to the coating agents. That is, in the printing method according to the comparative example, it is not possible to obtain a glossy color ink image, and the image quality deteriorates due to the coating agent having a large particle.

Particularly, in the comparative example, since a large amount of the coating agents are ejected once so as to cover the entire surface of the color ink image, the amount of the coating agent ejected from one nozzle increases. For this reason, a gap between the water droplets of the coating agents landed on the sheet S is comparatively small. Accordingly, as shown in FIG. 3, close particles of the coating agents are easily connected to each other, and a large particle of the coating agent is easily formed. For example, even when the coating agents are ejected by ensuring a gap between the particles of the coating agents so that the particles are not connected to each other, since the coating agents are cured in the state where the particles of the coating agents are distant from each other, it is not possible to improve the uneven state of the image surface, and to obtain a glossy image.

In addition, when the coating agents are ejected onto the image surface in the state where the color ink image is not perfectly cured by UV light (hereinafter, referred to as a half cured state), the color ink image is absorbed into the coating agents. For this reason, it is necessary to eject the coating agents onto the color ink image in the state where the color ink image is perfectly cured (hereinafter, referred to as a perfectly cured state). However, when the color ink forming the image is perfectly cured, the coating agents ejected onto the color ink image are more easily bounced. The fact that the coating agents are easily bounced indicates that the coating agents ejected onto the color ink image are easily maintained in the form of particles, and the particles of the coating agents are easily connected to each other to thereby easily form a large particle. For this reason, when the coating agents are ejected once onto the perfectly cured color ink image as in the comparative example in order to prevent the color ink image from being absorbed into the coating agents, a large particle is formed on the color ink image, which deteriorates the uneven state of the image surface.

Therefore, an object of this embodiment is to obtain a glossy image by ejecting a coating agent (UV curing colorless transparent ink) on the image formed by the UV curing color ink. In other words, an object of this embodiment is to obtain a glossy image formed on a medium by ejecting a coating agent onto the medium having a characteristic in which the coating agent is not absorbed, but is bounced.

### Printing Method According to this Embodiment

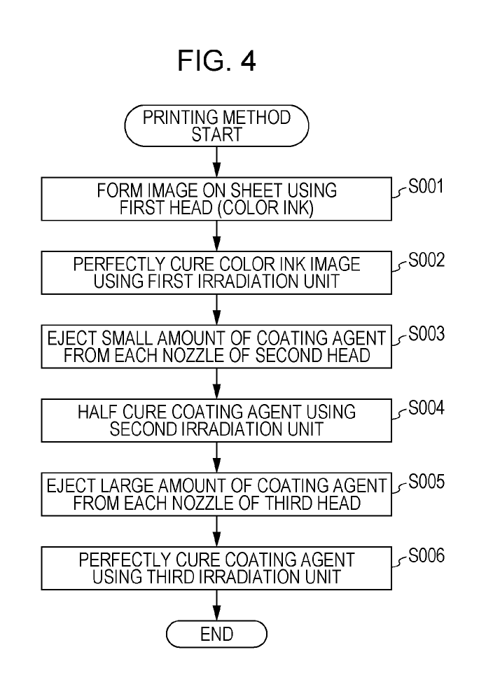

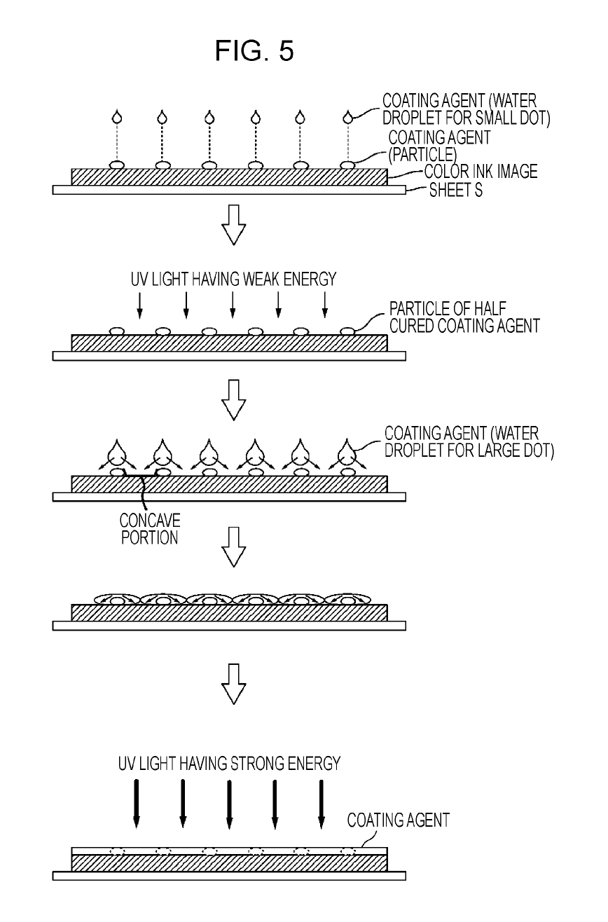

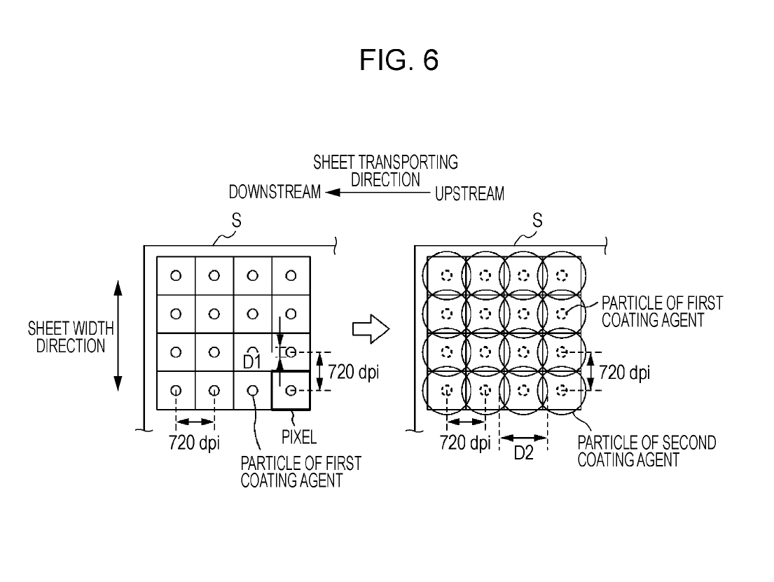

FIG. 4 is a flowchart illustrating a printing method according to this embodiment. FIG. 5 is a diagram illustrating the printing method according to this embodiment. FIG. 6 is a diagram illustrating a pixel (a unit area virtually defined on the sheet) onto which the coating agent is ejected. In addition, as shown in FIGS. 2A and 2B, in the printer 1 according to this embodiment, ink is ejected from each of the heads onto the sheet S and UV light is irradiated thereto from each of the irradiation units while the sheet S is transported. For this reason, the coating agents may be ejected onto the color ink image in the front end of the sheet S, and the color ink image may be formed in the rear end of the sheet S. However, for the convenience of description, here, as shown in FIG. 5, it is assumed that the color ink image is formed on the sheet S and the coating agents are formed thereon.

The printing method according to this embodiment is controlled by the controller 10 (corresponding to the control unit) of the printer 1. First, UV curing color ink is ejected from the first head 31 onto the sheet S so as to form an image on the sheet S (S001 in FIG. 4). Subsequently, the color ink forming the image is cured by the UV light irradiated from the first irradiation unit 41 (S002). At this time, the first irradiation unit 41 irradiates the UV light having strong energy capable of perfectly curing the color ink forming the image. Accordingly, even when the coating agents are ejected onto the color ink image, it is possible to prevent a problem that the color ink image is absorbed into the coating agents.

Subsequently, the coating agents (the UV curing colorless transparent ink) are ejected from the second head 32 onto the color ink image (corresponding to the first operation in S003). At this time, the amount of the coating agent ejected from each of the nozzles is set to be small (an amount forming a small dot). Subsequently, the coating agents ejected onto the image are half cured by irradiating the UV light having small energy from the second irradiation unit 42 (corresponding to the second operation in S004). Accordingly, as shown in FIG. 5, the coating agents having small particles on the color ink image are half cured (the coating agents are not perfectly cured).

Subsequently, the second coating agents are ejected from the third head 33 onto the half cured coating agents and the color ink image (corresponding to the third operation in S005). At this time, the amount of the coating agent ejected from each of the nozzles is set to be a large amount (an amount forming a large dot), larger than the amount of the coating agent ejected from each of the nozzles of the second head 32. Accordingly, the coating agents flow into gaps (concave portions in FIG. 5) between the particles of the half cured coating agents. As a result, the coating agents on the color ink image are formed in a smooth planar state (flat surface) instead of the uneven state. Finally, the coating agents ejected onto the image are perfectly cured by irradiating the UV light having strong energy from the third irradiation unit 43 (corresponding to the fourth operation in S006).

That is, in the comparative example, the coating agents ejected once onto the color ink image are cured. However, in this embodiment, the coating agents ejected two times (plural times) onto the color ink image are cured. Accordingly, it is possible to uniformly cover the color ink image by using the coating agents, and to obtain a glossy image.

Next, the reason why the coating agents are ejected two times will be described. As shown in FIG. 5, in the case of ejecting the first coating agents, a small amount of coating agent is ejected from each of the nozzles onto the color ink image. In detail, as shown in FIG. 6, when the water droplet of the coating agent ejected from each of the nozzles is landed on the image, the water droplets of the coating agents are ejected while preventing the close particles of the coating agents from being connected to each other (from being closer to each other). For this reason, for example, the amount of the ejected coating agent is adjusted so that a diameter D1 (a diameter of the dot when the coating agent ejected from one nozzle is landed on the medium in the first operation) of the particle of the coating agent landed on the image is smaller than a gap (a (central) gap between dots when the coating agent ejected from the nozzle is landed on the medium in the first operation in the case of 720 dpi) between pixels on the sheet S in the sheet transporting direction and the sheet width direction. Accordingly, the water droplet of the coating agent ejected from one nozzle is half cured in the form of a small particle without being connected to the water droplets of the coating agents ejected from the other nozzles. In other words, it is possible to prevent a problem that plural particles of the coating agents are connected to each other to thereby form a large particle of the coating agent on the image as in the comparative example shown in FIG. 3. In addition, the invention is not limited to the example in which the water droplet of the coating agent ejected from one nozzle is half cured in the form of a separate particle. That is, small particles of a small amount of coating agent may be connected to each other if the particle of the coating agent does not increase to a size in which the particle is recognized by a person as in the comparative example.

Accordingly, as shown in FIG. 5, the concave portions are formed on the color ink image due to the coating agents half cured in the form of small particles. The water droplets of the second coating agents ejected from the nozzles are merged with the particles of the half cured coating agents, and flow into the concave portions. Then, the water droplets of the coating agents flowing into the concave portions are connected to each other to thereby fill the concave portions with the coating agents. That is, since the particles of the half cured coating agents are formed on the image, it is possible to prevent a problem that the plural water droplets of the second ejected coating agents are connected to each other in disorder to thereby form a large particle of the coating agents (for example, the comparative example shown in FIG. 13). In other words, by means of the particles of the half cured coating agents, it is possible to prevent a problem that the water droplets of the second ejected coating agents are bounced and moved on the image. As a result, it is possible to uniformly fill all the concave portions with the coating agents. However, in order to uniformly fill the concave portions with the coating agents, it is necessary to cure the particles of the first ejected coating agents so as to stay at the current positions thereof.

In addition, when the amount of the second ejected coating agents is small, it is not possible to perfectly fill the concave portions. For this reason, the amount of the second coating agent ejected from each of the nozzles is set to be larger than that of the first coating agent ejected from each of the nozzles. Accordingly, it is possible to reliably fill the concave portions, formed between the particles of the first ejected coating agents, with the second ejected coating agents. As a result, it is possible to uniformly cover the entire surface of the color ink image with the coating agents without curing the coating agents in an uneven state. That is, it is possible to smoothen the surface of the color ink image, and thus to obtain a glossy image.

To sum up, even in the case where the coating agents are ejected onto a surface in which the coating agents are easily bounced as in the surface of the image formed by the UV curing color ink, since the operation of ejecting and curing the coating agents by the UV ray is performed two times, it is possible to prevent a problem that the particles of the coating agents increase in size and the image surface is formed in an uneven state. In addition, it is possible to fill gaps (concave portions) between the particles of the first ejected cured coating agents with the second ejected coating agents. As a result, since the entire image surface is uniformly covered by the coating agents, it is possible to obtain a glossy image.

Particularly, when the color ink forming the image is perfectly cured so that the color ink image is not absorbed into the coating agents, the coating agents are more easily bounced thereon. However, in the coating agent ejecting method according to this embodiment, it is possible to prevent a large particle of the coating agent from being formed on the image, and thus to smoothen the image surface. Additionally, in this embodiment, the coating agents are ejected two times, but the invention is not limited thereto. That is, the coating agents may be ejected two or more times. For example, after the second coating agents are filled into gaps (concave portions) between the particles of the first ejected coating agents, the coating agents may not be perfectly cured so as to be half cured, and the third coating agents may be ejected thereon.

In the coating agent ejecting method according to this embodiment, even in the surface of the color ink image (an image formed by irradiating an electromagnetic wave to a colored fluid) where the coating agents are easily bounced, it is possible to uniformly cover the image surface with the coating agents just by ejecting the coating agents thereto. For example, it is assumed that a type of ink different from the coating agents, for example, ink spreading on the color ink image is ejected onto the color ink image and then the coating agents are ejected thereto. Then, since the different type of ink is ejected onto the image, a problem arises in that the color of the lower image is dark. On the contrary, in this embodiment, since only the coating agents are ejected onto the color ink image, the color of the lower image is transparent and clean, thereby obtaining a high-quality image.

In this embodiment, in the state where the first ejected coating agents are half cured, the second coating agents are ejected thereto. For this reason, the energy of the UV light of the second irradiation unit 42 for irradiating the UV light to the first ejected coating agents is set to be weaker than that of the third irradiation unit 43 for irradiating the UV light to the second ejected coating agents. In addition, the invention is not limited to the example in which the energy of the UV light of the second irradiation unit 42 is weakened, but for example, the irradiation time may be set to be short. Likewise, since the first ejected coating agents are half cured, the first ejected coating agents are merged with the second ejected coating agents, thereby further smoothening the surfaces of the coating agents. In addition, it is difficult to recognize the fact that the coating agents are ejected two times, and it is possible to allow the color of the lower image to be transparent. However, the invention is not limited thereto, but the first ejected coating agents may be perfectly cured.

As described above, in the first ejected coating agents, the water droplet of the coating agent ejected from one nozzle is half cured in the form of a small particle of the coating agent in the state where the water droplet is not connected to the water droplets of the coating agents ejected from the other nozzles or only a few water droplets are connected to each other. For this reason, the amount of the first coating agent ejected from one nozzle is set to be smaller than that of the second coating agent. Accordingly, as shown in FIG. 6, the first coating agent is ejected so that the close particles of the coating agents are not connected to each other. However, when a gap between the particles of the first ejected coating agents is set to be excessively large so that the particles of the coating agents are not connected to each other, it is difficult to perfectly fill gaps (concave portions) between the particles of the first coating agents with the second coating agents. Therefore, as shown in FIG. 6, the amount and the gap of the ejected coating agents are adjusted so that a gap (720 dpi) between the pixels on the sheet S in the sheet transporting direction and the sheet width direction, that is, a gap between the first ejected coating agents (a (central) gap of the dots when the coating agents ejected from the nozzles are landed on the medium in the first operation) is equal to or less than a diameter D2 of the particle of the second coating agent ejected from one nozzle (equal to or less than the diameter of the dot when the coating agent ejected from one nozzle is landed on the medium in the third operation).

That is, in order to prevent a problem that the particles of the coating agents are connected to each other in disorder to thereby form a large particle, a gap of the landing positions of the first coating agents ejected from the nozzles in the sheet transporting direction and the sheet width direction is adjusted so as not to be excessively close to each other. In addition, in order to fill gaps (concave portions) between the particles of the first ejected coating agents with the second ejected coating agents and to prevent a gap between the landing positions of the first coating agents ejected from the nozzles in the sheet transporting direction and the sheet width direction from being excessively distanced from each other, the amount of the coating agent ejected from each of the nozzles and the ejection gap in the sheet transporting direction and the sheet width direction are adjusted.

Further, in this embodiment, in the second head 42 and the third head 43 (FIG. 2B) for ejecting the coating agents, the nozzles are arranged in series at the gap of 720 dpi in the sheet width direction. For this reason, as shown in FIG. 6, in the case where the water droplet of the coating agent is landed on each pixel of 720 dpi in the sheet transporting direction and the sheet width direction, the coating agents are ejected from all nozzles included in the second head 42 and the third head 43. Then, whenever the sheet S is transported by 720 dpi in the sheet transporting direction, the coating agents may be ejected from the nozzles. However, in the case of using a head in which a gap in the sheet width direction between nozzles for ejecting the coating agent is narrow, in order to prevent a problem that the particles of the first ejected coating agents are connected to each other to thereby form a large particle, the coating agents may be ejected every nozzle gap. Meanwhile, in the case of using a head in which a gap in the sheet width direction between nozzles for ejecting the coating agents is wide, in order to fill gaps (concave portions) between the particles of the first ejected coating agents with the second ejected coating agents, the first coating agents may be ejected by using plural heads of which the nozzle rows are deviated from each other in the sheet width direction.

### MODIFIED EXAMPLE

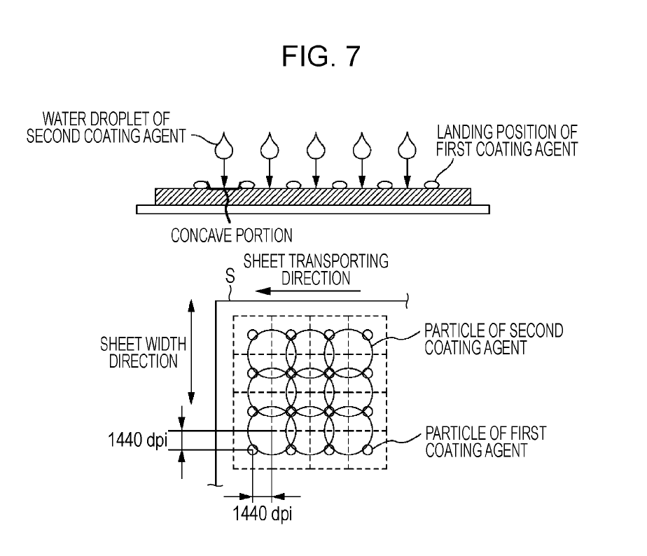

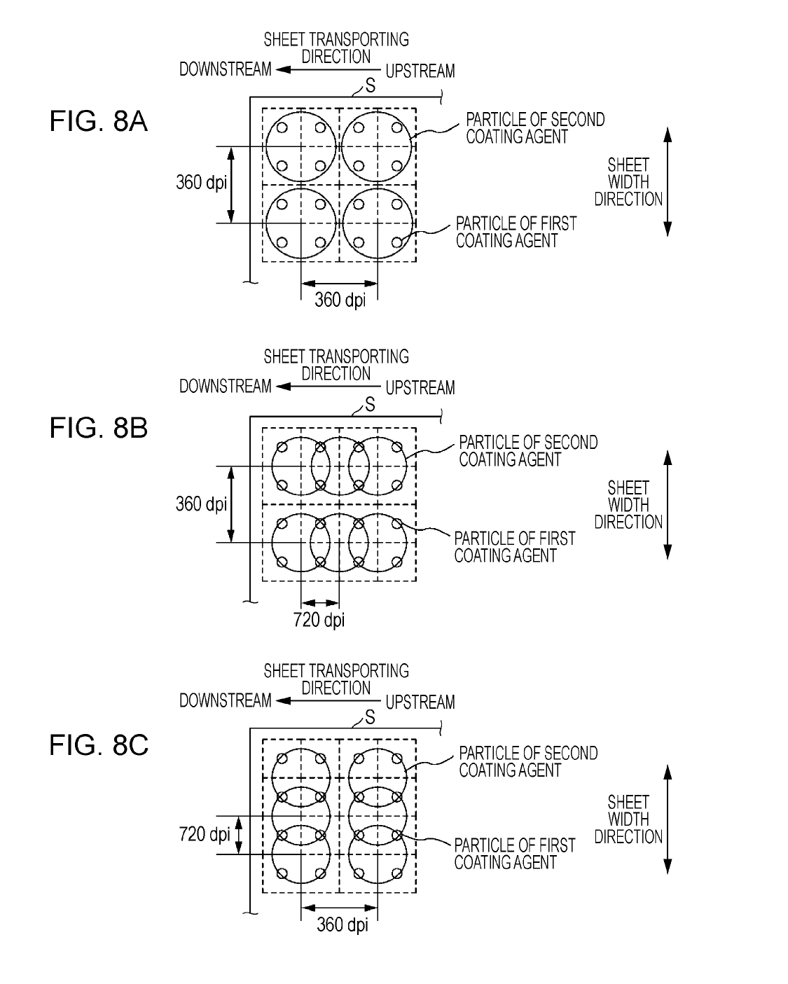

FIGS. 7, 8A to 8C are diagrams illustrating the coating agent ejecting method according to a modified example. As described above, in this embodiment (FIG. 5), the surfaces of the coating agents are smoothened by filling gaps (concave portions) between the particles of the first ejected cured coating agents with the second ejected coating agents. Therefore, in order to easily fill the gaps (concave portions) between the particles of the first ejected cured coating agents with the second ejected coating agents, the landing positions (the landing positions of the coating agents ejected in the first operation) of the water droplets of the first ejected coating agents may be deviated from the landing positions (the landing positions of the coating agents ejected in the third operation) of the water droplets of the second ejected coating agents. This is because the water droplets of the first ejected coating agents are easily cured in the form of particles at the landing positions. Accordingly, when the landing positions of the coating agents are deviated from each other, the second ejected coating agents are landed on the concave portions, whereby the concave portions are easily filled by the coating agents. For example, in FIG. 7, the landing positions of the first ejected coating agents and the landing positions of the second ejected coating agents are deviated from each other by 1440 dpi in the sheet transporting direction and the sheet width direction. Likewise, in order to deviate the landing positions of the coating agents from each other, the nozzles of the second head 42 and the nozzles of the third head 43 are deviated from each other in the sheet width direction by a half pitch (1440 dpi) so that the timing at which the coating agents are ejected from the second head 42 is deviated from the timing at which the coating agents are ejected from the third head 43.

In addition, in this embodiment, the amount of the second coating agent ejected from one nozzle is larger than that of the first coating agent ejected from one nozzle. Here, as shown in FIG. 8A, the gap of the first ejected coating agents in the sheet transporting direction and the sheet width direction may be set to “720 dpi”, and the gap of the second ejected coating agents in the sheet transporting direction and the sheet width direction may be set to “360 dpi”. Accordingly, it is possible to decrease the number of nozzles arranged in the third head 43 in the sheet width direction compared with the second head 42, and to easily control the ejecting operation.

Further, instead of the printer 1 (FIG. 2A) according to this embodiment in which the sheet is transported below the fixed head, in a printer (so-called serial type printer) in which an image forming operation performed by moving a head in a moving direction intersecting a nozzle row direction and a sheet transporting operation performed in the nozzle row direction are repeated, it is possible to shorten the printing time by widening a gap of the second ejected coating agents in the moving direction.

Furthermore, the invention is not limited to the example in which the gap of the second ejected coating agents in the sheet transporting direction and the sheet width direction is set to be wider than that of the first ejected coating agents as shown in FIG. 8A. That is, the gap of the second ejected coating agents in the sheet width direction may be widened as shown in FIG. 8B, or the gap of the second ejected coating agents in the sheet transporting direction may be widened as shown in FIG. 8C.

### OTHER EMBODIMENTS

While the fluid ejecting apparatus or the like according to the embodiment of the invention has been described, the above-described embodiment is just used to easily understand the invention, but the invention is not limited thereto. The invention may be, of course, modified and corrected without departing from the spirit of the invention, and may include the equivalents thereof.

In the above-described embodiment, the UV curing colorless transparent ink is used as the coating agent, but the invention is not limited thereto. For example, the coating agent may be ink having transparency capable of seeing the lower image, that is, semitransparent ink. In addition, the coating agent is not limited to the UV curing ink. For example, the coating agent may be ink cured by an electromagnetic wave such as an electron beam, an X-ray, a visible ray, or an infrared ray.

In the above-described embodiment, the coating agent is ejected onto the image formed by the UV curing color ink, but the invention is not limited thereto. For example, a medium not having an image formed thereon may be used, and the medium is not limited to the paper sheet, but may be, for example, plastic or metal. As the medium to which the coating agent is ejected, a material having a characteristic in which the coating agent is not absorbed, but is bounced may be effectively used in the invention.

In the above-described embodiment, the printer (so-called line head printer) is exemplified which ejects ink onto a medium transported below a head and an irradiation unit, and cures the ink, but the invention is not limited thereto. For example, a serial type printer may be used which alternately repeats an ink curing operation performed by moving a head in a direction intersecting a nozzle row direction and ejecting ink onto a medium and a medium transporting operation performed in a nozzle row direction.

In the above-described embodiment, although the ink jet printer is exemplified as the coating agent ejecting apparatus, the invention is not limited thereto, but may be applied to various industrial apparatuses. For example, the invention may be applied to a silkscreen printing apparatus for printing a pattern on a cloth, a color filter manufacturing apparatus, a display manufacturing apparatus for manufacturing an organic EL display or the like, or a DNA chip manufacturing apparatus for manufacturing a DNA chip by applying a solution of DNA to a chip.

Further, the coating agent ejecting method may be a piezoelectric method of ejecting a liquid by applying a voltage to a driving element (piezoelectric element) to expand or contract an ink chamber or a thermal method of ejecting a liquid by using a bubble generated inside a nozzle through a heating element.

What is claimed is:

1. A method of ejecting a coating agent cured by irradiation of an electromagnetic wave, the method comprising:
a first operation which ejects the coating agent onto a medium;
a second operation which is performed after the first operation so as to irradiate an electromagnetic wave to the coating agent ejected onto the medium in the first operation;
a third operation which is performed after the second operation so as to eject the coating agent onto the medium; and
a fourth operation which is performed after the third operation so as to irradiate the electromagnetic wave to the coating agent ejected onto the medium in the third operation.

2. The method according to claim 1,
wherein an amount of the coating agent ejected from one nozzle in the first operation is smaller than an amount of the coating agent ejected from one nozzle in the third operation.

3. The method according to claim 1,
wherein energy of the electromagnetic wave irradiated to the coating agent in the second operation is weaker than energy of the electromagnetic wave irradiated to the coating agent in the fourth operation.

4. The method according to claim 1,
wherein before the first operation, a colored fluid cured by the irradiation of the electromagnetic wave is ejected onto the medium, and then the electromagnetic wave is irradiated to the colored fluid ejected onto the medium so as to form an image on the medium, and
wherein in the first operation, the coating agent is ejected onto the image.

5. The method according to claim 1,
wherein a landing position of the coating agent ejected from nozzles onto the medium in the first operation is deviated from a landing position of the coating agent ejected from the nozzles onto the medium in the third operation.

6. The method according to claim 1,
wherein a dot gap when the coating agent ejected from nozzles is landed on the medium in the first operation is equal to or less than a dot diameter when the coating agent ejected from one nozzle is landed on the medium in the third operation.

7. The method according to claim 1,
wherein a dot diameter when the coating agent ejected from one nozzle is landed on the medium in the first operation is smaller than a dot gap when the coating agent ejected from nozzles is landed on the medium in the first operation.

8. An apparatus for ejecting a coating agent cured by irradiation of an electromagnetic wave, the apparatus comprising:
a nozzle which ejects the coating agent;
an irradiation unit which irradiates the electromagnetic wave for curing the coating agent; and
a control unit which causes the apparatus to perform:
a first operation which ejects the coating agent onto a medium;
a second operation which is performed after the first operation so as to irradiate an electromagnetic wave to the coating agent ejected onto the medium in the first operation;
a third operation which is performed after the second operation so as to eject the coating agent onto the medium; and
a fourth operation which is performed after the third operation so as to irradiate the electromagnetic wave to the coating agent ejected onto the medium in the third operation.
